(19) United States
(12) Patent Application Publication
(10) Pub. No.: US 2015/0043214 A1
(43) Pub. Date: Feb. 12, 2015

(54) LIGHTING DEVICE

(71) Applicant: Kabushiki Kaisha Toshiba, Minato-ku (JP)

(72) Inventors: Tomoyuki SUZUKI, Kawasaki (JP); Hiroshi OHNO, Yokohama (JP); Katsumi HISANO, Matsudo (JP); Hiroaki HIRAZAWA, Kawasaki (JP); Tomonao TAKAMATSU, Kawasaki (JP); Mitsuaki KATO, Kawasaki (JP)

(73) Assignee: Kabushiki Kaisha Toshiba, Minato-ku (JP)

(21) Appl. No.: 14/451,603

(22) Filed: Aug. 5, 2014

(30) Foreign Application Priority Data
Aug. 9, 2013 (JP) 2013-166916

(51) Int. Cl. F21V 29/00; F21V 23/02; F21K 99/00

(52) U.S. Cl. CPC F21V 29/262; F21K 9/1355; F21K 9/50; F21V 23/023; F21V 29/2212; F21V 29/004; F21Y 2101/02
USPC 362/294

(57) ABSTRACT

A lighting device of an embodiment includes: a light-emitting element; an optical lens positioned on a positive direction side of an axis perpendicular to a light-emitting surface of the light-emitting element with a point of origin being set on a center of the light-emitting surface; a plurality of heat dissipation fins arranged on a negative direction side of the axis and around the axis that serves as a central axis, and arranged so as not to be present within a range of a 1/2 light distribution angle of light emitted from the optical lens in the positive direction, and being thermally connected to the light-emitting element; a cover housing the heat dissipation fins having at least one opening in each of the positive and negative direction sides; and a base member positioned along the axis and thermally connected to the light-emitting element and the heat dissipation fins.

### CROSS REFERENCE TO RELATED APPLICATIONS

This application is based upon and claims the benefit of priority from the prior Japanese Patent Application No. 2013-166916, filed on Aug. 9, 2013, the entire contents of which are incorporated herein by reference.

### FIELD

Embodiments described herein relate generally to lighting devices.

### BACKGROUND

Lighting devices using light-emitting diodes (LEDs) show superior environmental performance (long lifespan, low power consumption, non-use of mercury, etc.) to incandescent lamps and fluorescent lamps, and are therefore expected to replace these prevailing types of lighting devices. Various new types of lighting devices using LEDs are also proposed. Thus, expectations for such lighting devices are rising. Lighting devices using LEDs are heat-sensitive due to their containing semiconductors, whose typical maximum rating junction temperature is in the range of 100° C. to 150° C. LEDs virtually emit no infrared, and about 70% of the power consumed by LEDs is converted into heat. Therefore, a design for heat dissipation that allows heat to be conducted to a heatsink and dissipated is important.

Conventional LED light bulbs are designed to convey most of the heat generated by LEDs to a heatsink by heat conduction through a base connected to the LEDs, the heat then being dissipated into the environment by natural convection and radiation. In order to improve heat conductivity, the base member and the heatsink arranged on the outer side of the globe are made of a metal or ceramic of a high thermal conductivity. Furthermore, the heat transfer is improved by increasing the surface area of the heatsink by, for example, employing a fin structure to enhance natural convection, or by employing a special coating for improved emissivity. The dependency of such structures on heat dissipation from the outer surface of the LED light bulb, however, leads to increased dimensions if a higher output is to be achieved. This causes problems of compatibility with devices and light output, and of the appearance.

In order to solve the above problems, a structure is proposed to form an opening in an LED light bulb to use the inner surface thereof as a heat dissipation surface. In the proposed LED light bulb, the LEDs are arranged between fins to convey light emitted from the LEDs to a wide area of the globe, for a wide distribution of light. However, the fins also act as screens, and increasing the number of fins and employing complex fin structures to improve the heat dissipation performance leads to a degradation of device efficiency. Thus, it is a trade-off between light and heat dissipation efficiency.

In addition, since the diameter of a cylindrical body located at the center of the LED light bulb needs to be increased to ensure a space for a plurality of LEDs, the inner space of the LED light bulb decreases. For this reason, the interior of the LED light bulb cannot be used effectively as a heat dissipation region.

Furthermore, in order to efficiently convey the heat of the LEDs to the cylindrical body, the section of the cylindrical body should be such that the cylindrical body is in surface contact with the LEDs or substrate.

Moreover, since the LEDs are positioned between the fins, the number of LEDs should exceed the number of fins to prevent shadow formation. This raises the problem that a single light source of large output cannot be employed.

Since the LEDs are positioned inside of air flow, the light source is easily affected by dust, etc. This blocks light and decreases the lighting efficiency of the device.

Also, the spatial positioning of LEDs puts a great strain on manufacturing processes.

Due to the foregoing reasons, the dissipation surface area inside the LED light bulb cannot be sufficiently obtained. Therefore, in order to achieve a high output, the dissipation surface area, i.e., the size, of the LED light bulb increases.

### BRIEF DESCRIPTION OF THE DRAWINGS

FIG. 1 is a cross-sectional view of a lighting device according to a first embodiment.

FIG. 2A is a cross-sectional view of a first specific example of the connection of a light-emitting element and an optical lens in the first embodiment.

FIG. 2B is a cross-sectional view of a second specific example of the connection of a light-emitting element and an optical lens in the first embodiment.

FIG. 3 is a diagram showing an external appearance of the lighting device according to the first embodiment.

FIG. 4 is a diagram showing an external appearance of a lighting device according to a first modification of the first embodiment.

FIG. 5 is a cross-sectional view showing an LED light bulb according to Comparative Example.

FIG. 6 is a diagram showing a contacting state of heat dissipation fins and a cover of the lighting device according to the first embodiment.

FIG. 7 is a diagram showing a contacting state of heat dissipation fins and a cover of the lighting device according to the first embodiment.

FIG. 8 is a diagram showing an external appearance of a lighting device according to a second modification of the first embodiment.

FIGS. 9(a) and 9(b) are cross-sectional views of a lighting device according to a second embodiment.

FIG. 10 is a diagram showing a relationship between average heat transfer coefficient obtained by natural convection between parallel flat plates, and interval of the flat plates.

FIG. 11 is a diagram showing a relationship between fin efficiency of rectangular fin and average heat transfer coefficient.

FIGS. 12(a) and 12(b) are cross-sectional views of a lighting device according to a third embodiment.

FIG. 13 is a diagram showing an external appearance of a lighting device according to a fourth embodiment.

### DETAILED DESCRIPTION

A lighting device according to an embodiment includes: a light-emitting element having a light-emitting surface; an optical lens positioned on a positive direction side of an axis that is perpendicular to the light-emitting surface of the light-emitting element with a point of origin being set on a center of the light-emitting surface, a positive direction of the axis being determined as a direction in which light is emitted; a plurality of heat dissipation fins arranged on a negative direction side of the axis and around the axis that serves as a central axis, the heat dissipation fins being arranged so as not to be present within a range of a 1/2 light distribution angle of light emitted from the optical lens in the positive direction, and the heat dissipation fins being thermally connected to the light-emitting element; a cover housing the heat dissipation fins, being shaped like a body of rotation with the axis serving as a rotation axis, and having at least one opening in each of the positive direction side and the negative direction side of the axis; and a base member positioned along the axis and thermally connected to the light-emitting element and the heat dissipation fins.

Embodiments will now be explained with reference to the accompanying drawings. In the descriptions of the drawings, the same or similar elements are denoted by the same or similar reference codes.

### First Embodiment

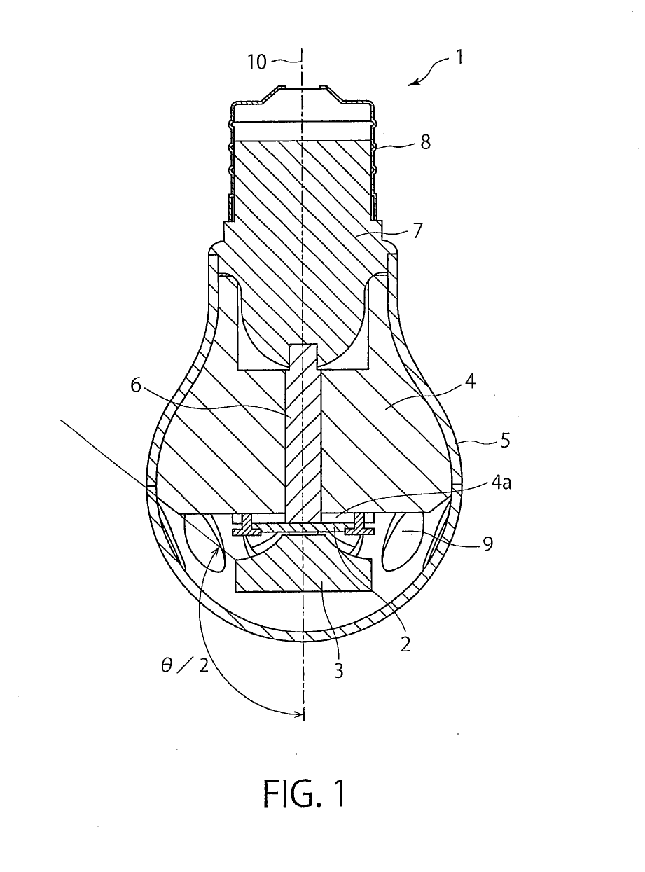

FIG. 1 shows a cross-sectional view of a lighting device including LEDs according to a first embodiment. The lighting device 1 according to the first embodiment includes a light-emitting element 2, an optical lens 3, heat dissipation fins 4, a cover 5, a base member 6, a power supply unit 7, and a base 8.

It is assumed that there is an axis 10 with the point of origin set on the center of the light-emitting surface of the light-emitting element 2 including LEDs, the axis 10 being perpendicular to the light-emitting surface and the direction in which light is emitted being set as a positive direction. The optical lens 3 is located on the positive direction side of the axis 10. The optical lens 3 is made of a material having a high transmittance such as poly-methyl-methacrylate (PMMA), and widely distributes light emitted from the light-emitting element 2 with high directivity. The first embodiment has an advantage in that the light source is unlikely to be affected by dust since the light-emitting surface of the light-emitting element 2 does not face the main stream of air flow.

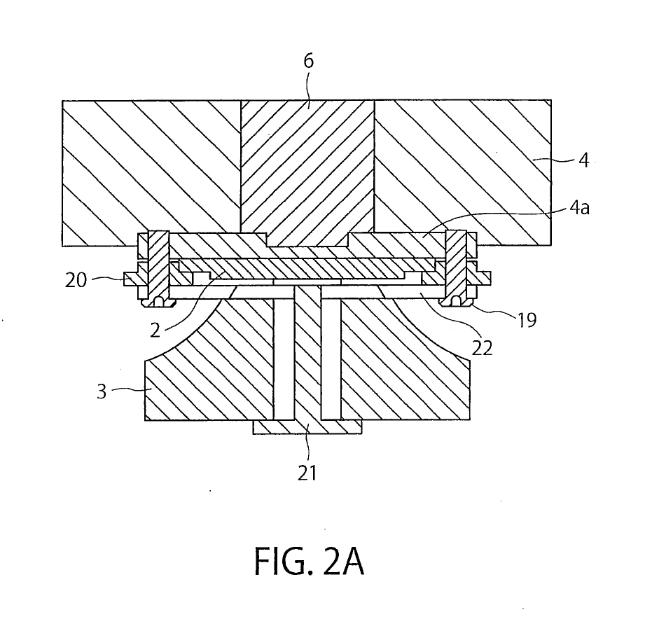

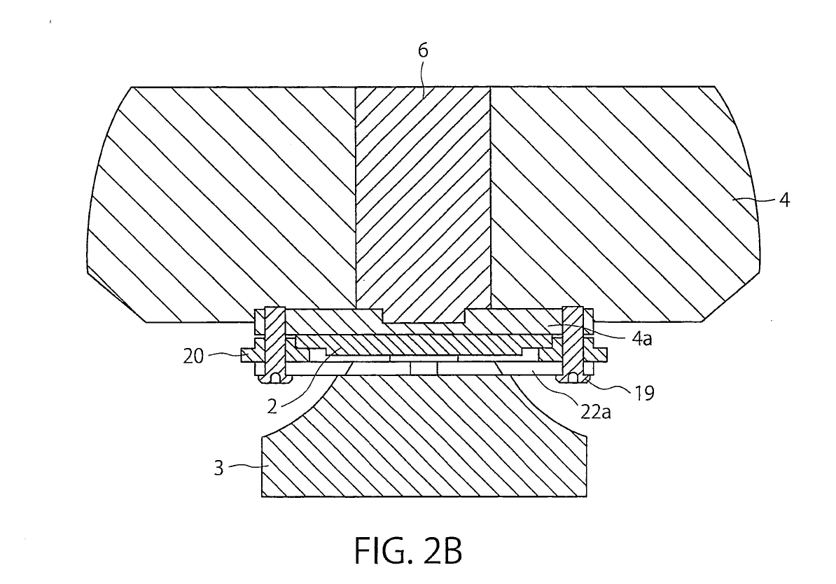

The optical lens 3 is coupled to the light-emitting element 2. FIG. 2A shows a first specific example of the coupling. The coupling method of the first specific example uses the optical lens 3 with a through-hole at the central portion thereof. The optical lens 3 is fixed to a second fixing member (for example, flat plate) 22 by a first fixing member (for example, screw) 21 penetrating the aforementioned through-hole. The first fixing member 21 and the second fixing member 22 are made of a material having a high transmittance, such as an acrylic material. Thermal deformation caused by heat emitted from LEDs can be prevented by forming the second fixing member with a highly heat resistant and transparent material such as heat-resistant glass. If the first fixing member 21 is a screw, a threaded hole may be formed at the central portion of the second fixing member, and the male screw of the first fixing member 21 is screwed and fastened into the female screw of the second fixing member. The first fixing member may also serve as a part of the optical lens 3. More than one through-hole is formed through the periphery portion of the second fixing member 22. A base member 4a with more than one, for example four, screw holes corresponding to the through-holes of the second fixing member 22 is provided between the base member 6 and the second fixing member 22. The second fixing member 22 is fixed to the base member 4a by bolts 19 with spacers 20. The light-emitting element 2 is also fixed to the base member 4a by the spacers 20. The base member 4a and the base member 6 are bonded to each other by, for example, a bonding agent or heat conductive tape, or simply fitted to each other via thermal grease. The first specific example has the following advantages. First, each element of the first specific example is easy to be formed by molding. Since each element are fixed by screws, each element puts lower load on the process than bonding. Second, the lens can be easily changed in accordance with the size of the LEDs. If the second fixing member 22, the bolts 19, and the spacers 20 are made common for all the lighting devices 1 with different outputs, only the light-emitting element 2 and the optical lens 3 should be changed to vary the outputs.

FIG. 2B shows a second specific example of the coupling of the optical lens 3 and the light-emitting element 2. The optical lens 3 of the second specific example does not have any through-hole at the central portion thereof. The optical lens 3 is integrally formed with a fixing member 22a using a material having a high transmittance, for example, an acrylic material, so that the optical lens 3 is positioned at and connected to the central portion of the fixing member 22a. Like the second fixing member 22 of the first specific example, the fixing member 22a has more than one through-hole on the periphery portion. A base member 4a with more than one, for example four, screw holes corresponding to the through-holes of the fixing member 22a is provided. The fixing member 22a is fixed to the base member 4a by bolts 19 with spacers 20. The light-emitting element 2 is also fixed to the base member 4a by the spacers 20. The base member 4a and the base member 6 are bonded to each other by, for example, a bonding agent or heat conductive tape, or simply fitted to each other via thermal grease.

The heat dissipation fins 4 are thermally connected with the light-emitting element 2, and arranged on the negative direction side of the axis 10 so as to radiate from the axis 10. The light-emitting element 2 is fixed to the heat dissipation fins 4 via the base member 4a. The fixing may use screws as shown in FIG. 1, or double-sided tape as will be described later. The base member 4a may be integrally formed with the heat dissipation fins 4.

A high device efficiency can be achieved by not arranging the heat dissipation fins 4 in the range of 1/2 light distribution angle of light emitted from the optical lens 3. Specifically, the light distribution angle a can be represented, based on the Etendue rule, by

θ=sin⁻¹(A/B)^{1/2}

where A denotes light-emitting area, and B denotes the light-emitting area of the lens. In this embodiment, a wide light distribution can be achieved by, for example, cutting outer corner portions of the heat dissipation fins 4. With such a structure, the positive direction side of the axis 10 can be treated as light region, and the negative direction side can be treated separately as dissipation region. As a result, the number of the light-emitting elements 2 and the number of the heat dissipation fins 4 can be determined independently of each other. Furthermore, this embodiment can be compatible with a single, high-output light source. Since the heat dissipation fins 4 do not block light, the shape of each fin can be complicated. Thus, the degree of freedom in design is improved. The heat dissipation fins 4 are made of a material with a high thermal conductivity, such as aluminum. The reflectivity of the heat dissipation fins 4 can be improved by mirror-finishing the surfaces thereof. The emissivity of the heat dissipation fins 4 can be improved by coating the surfaces thereof with an appropriate material. Openings such as holes can be formed through the heat dissipation fins 4. With such a structure, the lighting device may be installed so that the axis 10 extends in the horizontal direction. Specifically, air that rises due to natural convection passes through the openings of the heat dissipation fins, which prevents degradation of radiation performance.

The base member 6 is a body of rotation with the axis 10 serving as a rotation axis. The heat dissipation fins 4 are arranged and fixed around the base member 6. The heat dissipation fins 4 and the light-emitting element 2 are thermally connected with each other via the base member 6. Specifically, the heat dissipation fins 4 are directly connected to the base member 6, and the light-emitting element 2 is directly connected to the base member 6 and also indirectly connected to the base member 6 via the base member 4a and the heat dissipation fins 4. Therefore, it is important to reduce the thermal resistance from the light-emitting element 2 to the heat dissipation fins 4. From this point, the diameter of the base member 6 is preferably as great as possible. However, as the diameter of the base member 6 increases, the size of the heat dissipation fins 4 decreases. Therefore, the diameter of the base member 6 is set such that the temperature gradient does not increase too much in the direction of the axis 10. The base member 6 may be solid to reduce the thermal resistance. Alternatively, the base member 6 may be hollow to house wiring connecting the power supply unit 7 and the light-emitting element 2. A thermal interface material (TIM) such as thermal grease or heat conductive double-sided tape may be provided between the base member 6 and the light-emitting element 2 to reduce the contact thermal resistance. The base member 6 is made of a material with a high thermal conductivity such as aluminum. The base member 6 and the fins 4 may be integrally formed to reduce the base-fin contact thermal resistance. Alternatively, the base material 6 and the fins 4 may be separately formed to improve the productivity.

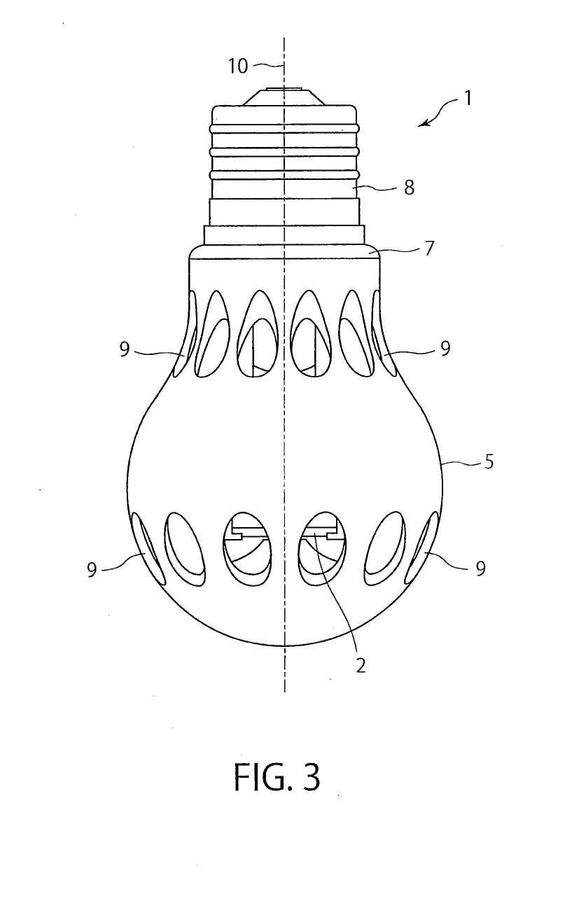

As shown in FIG. 3, the cover 5 has a shape of a body of rotation with the axis 10 serving as a rotation axis, and houses the light-emitting element 2, the optical lens 3, and the heat dissipation fins 4. More than one opening 9 is formed in each of the positive direction side and the negative direction side of the axis 10. The cover 5 may have various shapes such as a spherical, cylindrical or polygonal shape. The cover 5 may also have a spherical shape with a part thereof having a solid angle 2π□steradians or more.

The light emitted from the light-emitting element 2 is distributed by the optical lens 3. Therefore, the cover 5 is not necessarily made of a material having a sufficiently high refractive index, such as polycarbonate (PC), PMMA, or glass. For example, the cover 5 may be replaced with a madreporic body formed of paper such as Japanese paper or kite string. Thus, an application-customized design can be made. The heat dissipation performance can further be improved by having a portion outside the range of the 1/2 light distribution angle of the light emitted from the optical lens 3 to be made of a material with a high thermal conductivity such as a metal or ceramic, or material with a high emissivity. With the openings 9, air can be introduced into the cover 5, which exchanges heat with the heat dissipation fins 4. The position and the size of each opening 9 are not limited. If the openings are formed near the heat dissipation fins 4, the internal structure can be made unlikely to be seen, which allows a good design. The openings may be formed in a wide range to improve the heat dissipation performance.

The openings 9 may be slits to make the internal structure unlikely to be seen, as in a lighting device according to a first modification shown in FIG. 4. If the slits, the openings 9, are formed near the heat dissipation fins 4, the heat dissipation performance can be improved.

Depending on the positions of the openings 9, the air introduced may hit the optical lens 3. If the openings 9 are present in the positive direction side on the axis 10 relative to the optical lens 3, the flow resistance may be reduced by forming the optical lens 3 in a projecting shape or curved shape so that air can be easily introduced. The first modification has an advantage in that the light source is not affected by dust easily since the light-emitting surface of the light-emitting element 2 does not face the mainstream of air flow.

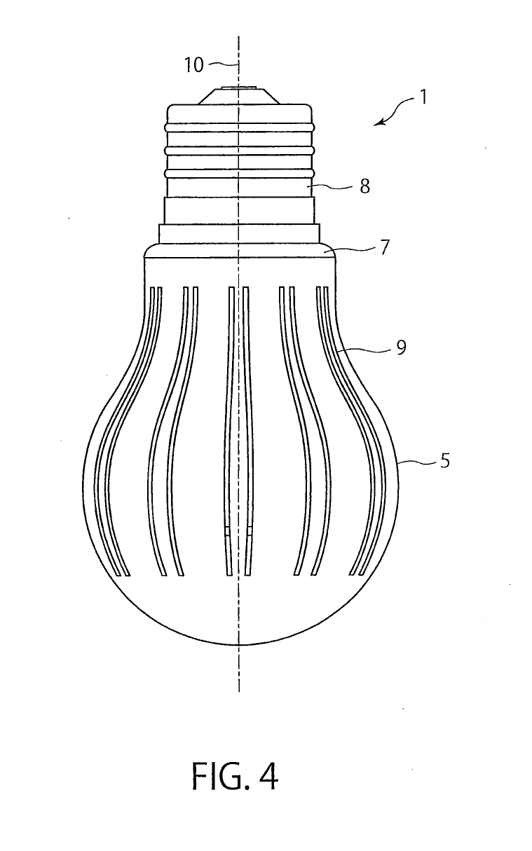

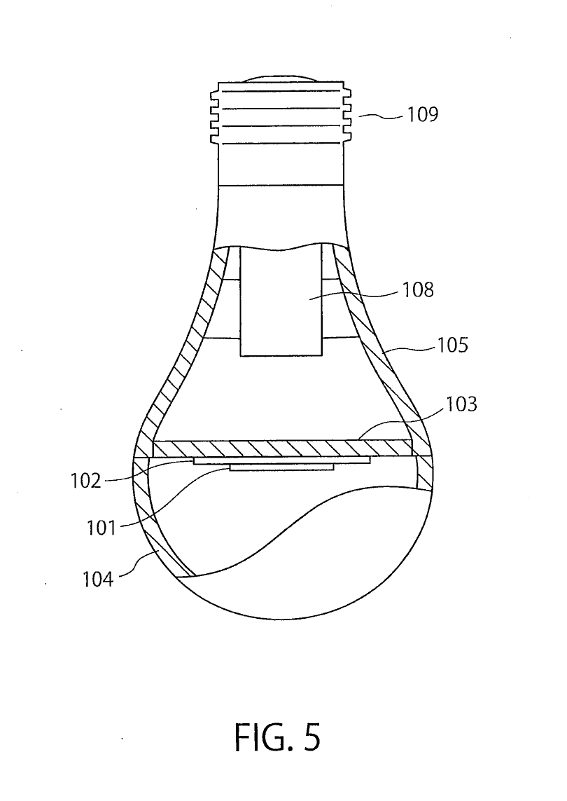

FIG. 5 shows a conventional LED light bulb as Comparative Example. The LED light bulb of Comparative Example conveys most of heat generated by LEDs 101 to a heatsink 105 via a substrate 102 and a base member 103 by heat conduction, and then emits the heat to the environment by natural convection and radiation. In FIG. 5, the reference numeral 104 indicates a cover, 108 indicates a power supply unit, and 109 indicates a base. The base member 103 and the heatsink 105 of Comparative Example are made of a metal or ceramic with a high thermal conductivity in order to have a good heat conductivity. The heat transfer of Comparative Example is intended to be further increased by increasing the surface area of the heatsink 105 (improving the fin structure) to enhance natural convection, or by employing a special coating for improved emissivity.

In contrast, the lighting device according to the first embodiment is capable of releasing heat within the cover 5 as shown in FIG. 1, and therefore achieving required heat-releasing performance with a downsized device without exposing metal or ceramic. Therefore, the lighting device according to the first embodiment requires no element corresponding to the heatsink 105 of Comparative Example, and the appearance thereof is close to that of an incandescent light bulb. Furthermore, in the first embodiment, an effect of producing no shadow by the heat dissipation fins 4 can be expected since the distance is long between the point from which light is emitted from the optical lens 3 and the point at which the light hits the cover 5. The reason for this is that light emitted from the optical lens 3 are widely dispersed by the time they reach the cover 5.

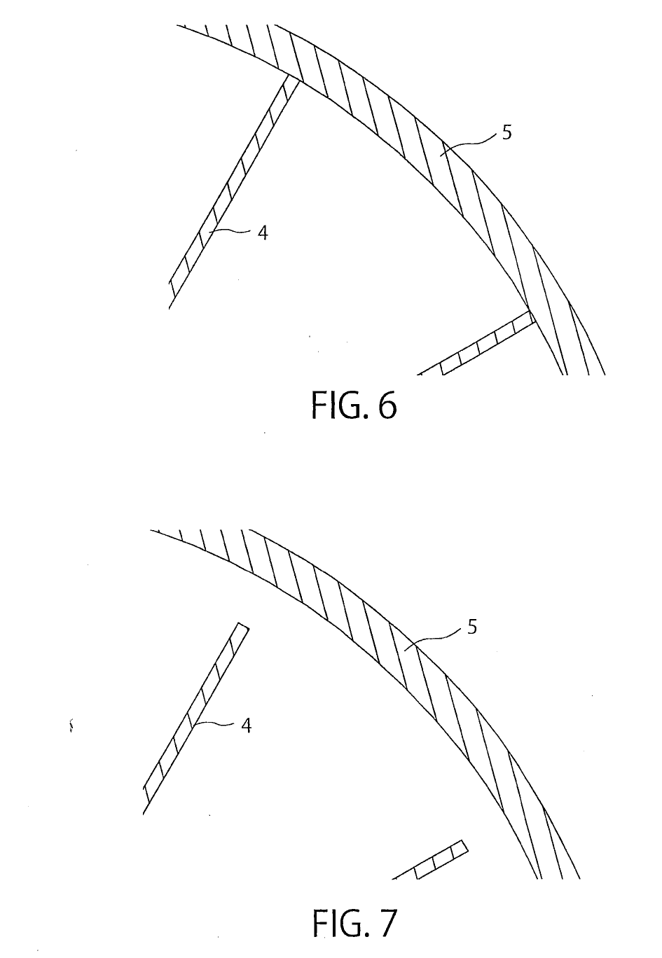

The heat dissipation fins 4 housed in the cover 5 may be shaped such that they contact the cover 5 to convey heat to the cover 5 as shown in FIG. 6 in order to improve heat dissipation performance. If the heat dissipation fins 4 are separated from the cover 5 as shown in FIG. 7, the shadows of the heat dissipation fins 4 may be unlikely to be seen from outside. If the cover 5 of the LED light bulb is formed in such a manner that separate components are prepared and bonded to each other, productivity may be improved.

The power supply unit 7 includes a power supply casing and a power supply circuit, and is positioned on the negative direction side of the axis 10. The power supply circuit is housed in the power supply casing connected to the base 8 for receiving a current from outside. The power supply unit 7 is screw-connected with the base member 6. Specifically, a male thread at the tip of the base member 6 on the side of the power supply unit 7 is screwed into a female thread hole in a corresponding recess of the power supply unit 7. In order to convey heat of the power supply circuit to the power supply casing, a resin or heat conduction grease may be filled into the power supply casing. The power supply unit 7 is preferably positioned so as not to contact the base member 6, the heat dissipation fins 4, and the cover 5 as much as possible so that the power supply circuit is not affected by heat generated by the light-emitting element 2. The power supply casing may be shaped to match the shape of the power supply circuit so that air may easily flow into and out of the cover 5. If the power supply unit 7 is positioned within the cover 5, the shape of the power supply unit 7 may be rounded to decrease the flow resistance of air within the cover 5. The power supply unit 7 may be located outside the cover 5 as in a second modification of the first embodiment shown in FIG. 8. In this case, a male thread is formed at the tip of the power supply unit 7, and a female thread corresponding to the male thread is formed inside the cover 5. Thus, the power supply unit 7 and the cover 5 are connected to each other by such a screw connection. The light-emitting element 2, the heat dissipation fins 4, etc. shown in FIG. 1 are omitted in FIG. 8.

As described above, according to the first embodiment, a lighting device using LEDs capable of increasing the output without decreasing the lighting efficiency and increasing the size can be provided.

### Second Embodiment

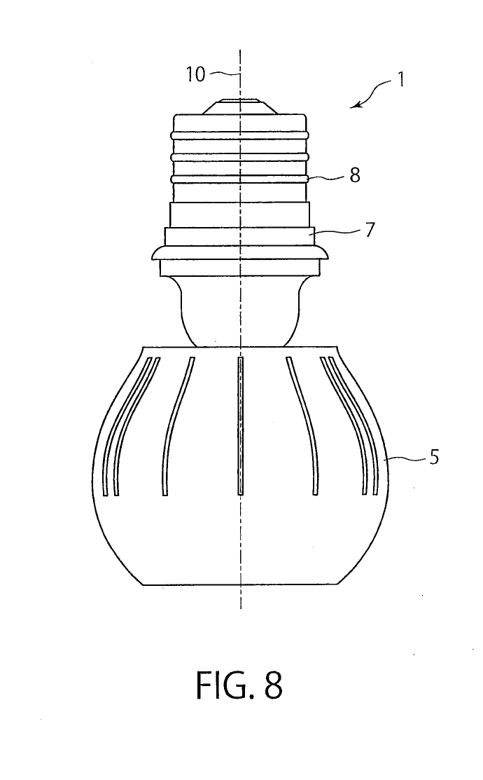

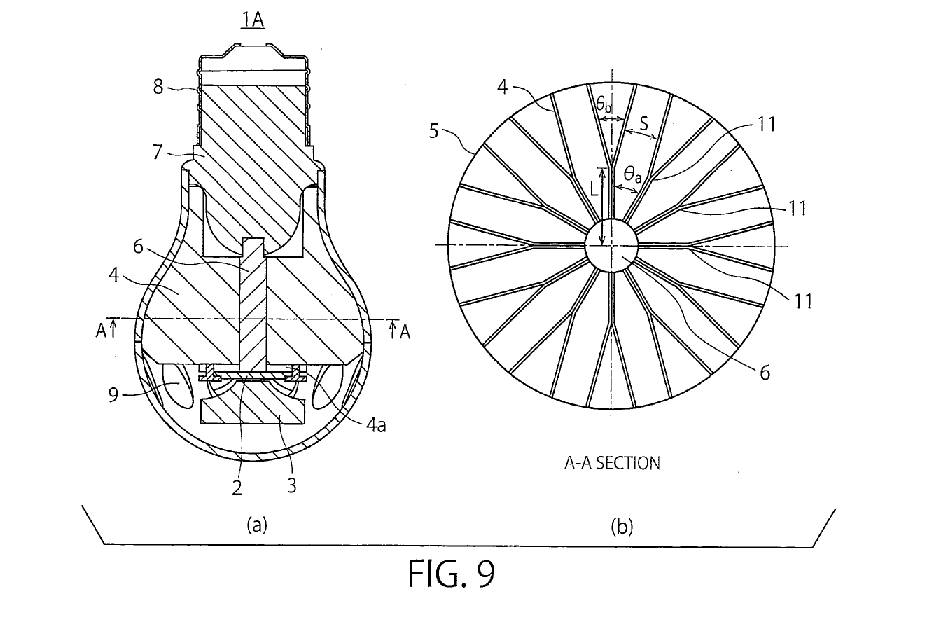

A lighting device using LEDs according to a second embodiment will be described with reference to FIGS. 9(a) to 9(b). FIG. 9(a) is a cross-sectional view of the lighting device 1A according to the second embodiment, and FIG. 9(b) is a cross-sectional view taken along line A-A in FIG. 9(a).

The lighting device 1A according to the second embodiment differs from the lighting device 1 shown in FIG. 1 in the shape of the heat dissipation fins 4. In the first embodiment, the heat dissipation fins 4 extend radially from the base member 6 surrounding the central axis 10 toward the cover 5. In the second embodiment, each of the heat dissipation fins 4 housed in the cover 5 first extends radially toward the cover 5, and then is branched to form a Y shape at point 11 located somewhere between the base member 6 and the cover 5. In this manner, the heat dissipation area can be expanded. If the angle θₐ between adjacent heat dissipation fins 4 and the branching angle θ_{b} are both set at θ, the distance S between adjacent heat dissipation fins 4 after the branching can be made constant by applying the following formulas:

$$S / 2 = {L}_{a} \times sin ( θ / 2 ) - t$$

$$S = 2 {L}_{a} \times sin ( θ / 2 ) - 2 t = {{L}_{a} ( 2 ( 1 - cos θ ) )}^{1 / 2} - 2 t$$

where t denotes the thickness of the heat dissipation fins 4, Lₐ denotes the distance from the center of the base member 6 (axis 10) to a point 11 on each heat dissipation fin 4. The condition under which the product of the heat transfer coefficient and the heat dissipation area obtained from the above formulas becomes a maximum can be determined using the distance S between adjacent heat dissipation fins 4 after the branching as a design parameter. A condition is preferable under which the fin efficiency depending on the thickness t of the heat dissipation fins 4, and the product of the heat transfer coefficient depending on the distance S between the heat dissipation fins 4 and the heat dissipation area depending on the angle θₐ between the heat dissipation fins 4 before the branding become a maximum.

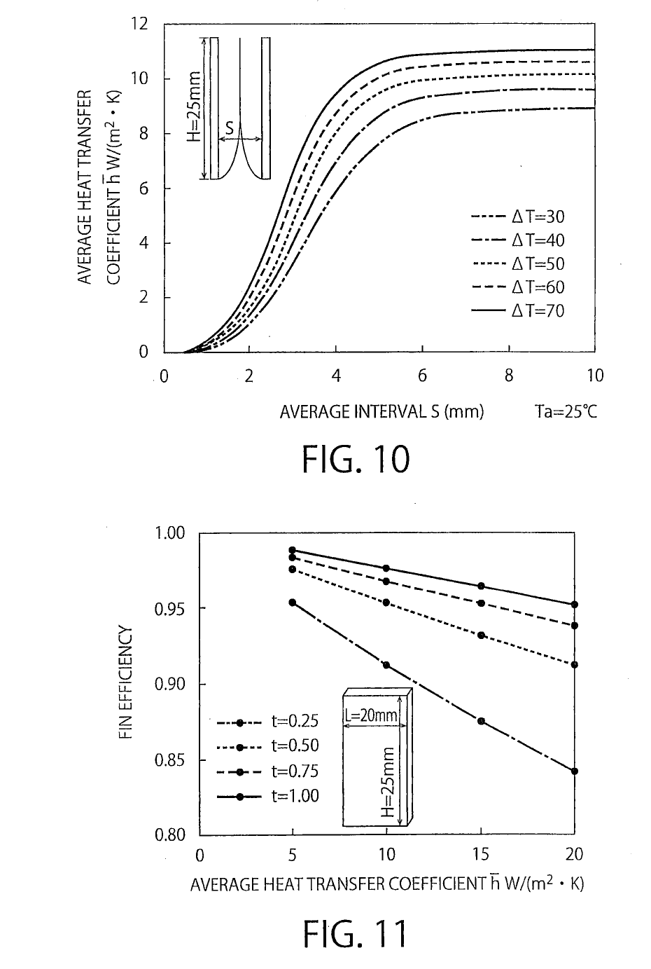

It is assumed that the height of the heat dissipation fins 4 is 25 mm for allowing the lighting device to be applied to an incandescent light bulb. Then, the relationship between the distance S and the heat transfer coefficient is obtained from the relational formula of natural convection between flat plates in vertical and parallel arrangement. As a result, the heat transfer coefficient reaches a value substantially corresponding to a convergence value when S is about 6 mm. It is known that natural convection between flat plates in a vertical and parallel arrangement at a temperature Tw that is higher than an ambient temperature Ta can be approximated by the following formula from BarCohen-Rohsenow:

$$\frac{\overline{h} S}{{k}_{a}} = {\{ {( \frac{1}{24} {Ra}_{S} \frac{S}{H} )}^{- 2} + {[ 0.59 {( {Ra}_{S} \frac{S}{H} )}^{1 / 4} ]}^{- 2} \}}^{- 1 / 2}$$

where /h denotes average heat transfer coefficient, S denotes interval between the parallel plates, ka denotes thermal conductivity of air, Ra_{S} denotes Rayleigh number of a representative length S, and H denotes height of the plates. FIG. 10 shows the average heat transfer coefficient /h for each temperature difference ΔT.

The fin efficiency η of a rectangular fin can be expressed by the following formula:

$$η = \frac{tanh ( mL )}{mL}$$

$$m = \sqrt{\frac{2 \overline{h}}{{k}_{f} t}} \sqrt{1 + \frac{t}{H}}$$

where L denotes fin length, /h denotes heat transfer coefficient, k_{f} denotes thermal conductivity of the fins, t denotes fin thickness, and H denotes fin width (height of the plates). FIG. 11 shows η for various fin thicknesses t when L is 20 mm and H is 25 mm.

From FIGS. 10 and 11, for the conditions that S is 5 mm, t is 0.5 mm, and the number of fins is 12, θ is 30°, and Lₐ is 11.6 mm. If the cover 5 is cylindrical, the surface area of the branched fins with the aforementioned dimensions is about 25×10⁻³ m². If it is assumed that /h is 10 W/m², and ST is 60 K, is about 0.95, and the amount of heat dissipation from the fins is about 14 W. This is greater than the amount of heat dissipation required for an LED light bulb to achieve total luminous flux corresponding to that of a 100-watt incandescent light bulb. Thus, by dividing the heat dissipation fins into branches as in the second embodiment, the heat dissipation of the heat dissipation fins 4 can be improved.

Like the first embodiment, a lighting device using LEDs according to the second embodiment is capable of increasing the output without decreasing the lighting efficiency and increasing the size.

### Third Embodiment

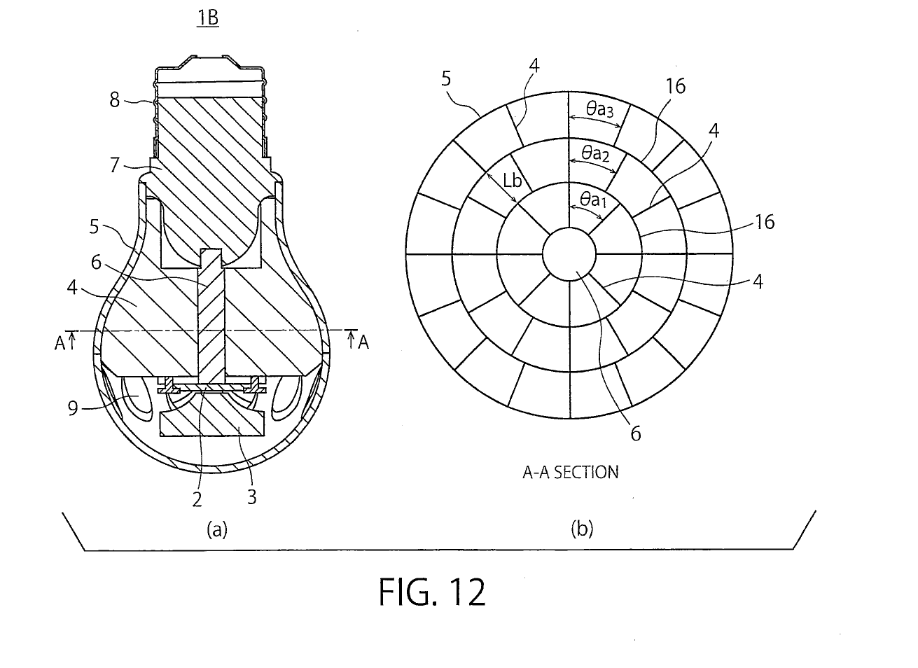

A lighting device according to a third embodiment will be described with reference to FIGS. 12(a) and 12(b). FIG. 12(a) is a cross-sectional view of the lighting device 1B according to the third embodiment, and FIG. 12(b) is a cross-sectional view taken along line A-A of FIG. 12(a).

The lighting device 1B according to the third embodiment differs from the lighting device 1 shown in FIG. 1 in the shape of the heat dissipation fins 4. In the lighting device according to the third embodiment, a pipe mechanism to expand the heat dissipation area is formed within the cover 5 with heatsinks 16 concentrically arranged with the axis 10 serving as a central axis and the heat dissipation fins 4. The heat dissipation fins 4 are arranged between adjacent heatsinks 16. The heat dissipation fins 4 are also arranged between the outermost heatsink 16 and the cover 5, and the innermost heatsink and the base member 6.

The design parameters of the third embodiment are the distances between adjacent fins θa₁, θa₂, θa₃, and the interval between the heatsinks L_{b}. Like the second embodiment, conditions under which the product of the heat transfer coefficient and the heat dissipation area becomes a maximum are determined. The distances between fins θa₁, θa₂, θa₃ are not needed to be the same value.

Like the second embodiment, the heat dissipation from the heat dissipation fins 4 of the third embodiment can be increased.

Furthermore, like the first embodiment, a lighting device using LEDs according to the third embodiment is capable of increasing the output without decreasing the lighting efficiency and increasing the size.

### Fourth Embodiment

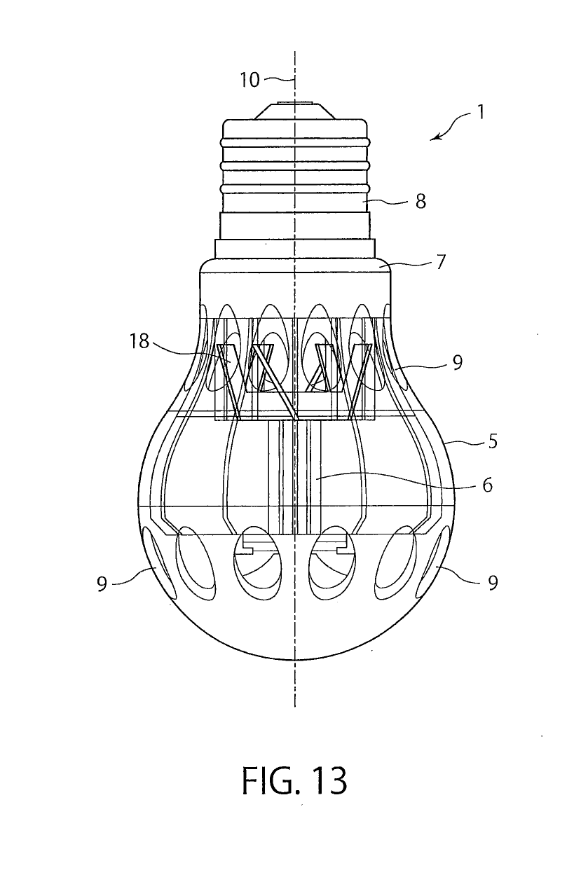

A lighting device according to a fourth embodiment will be described with reference to FIG. 13. FIG. 13 is a cross-sectional view of a lighting device 1C according to the fourth embodiment.

In the fourth embodiment, a rotation member 18 rotating around the axis 10 is provided inside the cover 5. The rotation member 18 generates forced convection, by which boundary layers of the heat dissipation fins 4 can be decreased. As a result, the heat transfer coefficient is increased, and the temperature of air near the heat dissipation fins 4 is lowered by increasing the mass flow rate of air inside the cover 5.

If the rotation member 18 is formed separately from the heat dissipation fins 4, any impediment placed in the rotation direction of the rotation member 18 should be removed to avoid any interference from the heat dissipation fins 4. Providing extra space may help avoiding any interference due to dimensional tolerance.

The heat dissipation fins 4 themselves may rotate to act as the rotation member 18. For example, the heat dissipation fins 4 can be rotated by rotating the base member 6. If a rotating mechanism is housed in the base member 6, the base member 6 should be made hollow. If the diameter of an opening to make it hollow is large, thermal resistance between the light-emitting element 2 and the heat dissipation fins 4 may be increased.

If the light-emitting element 2 is not rotated together, attention should be paid to twisting and entanglement of wiring. From the foregoing, if a rotating mechanism is housed in the base member 6 to rotate the heat dissipation fins 4, and the light-emitting element 2 is not rotated together, heat generated by the light-emitting element 2 may not be conveyed satisfactorily to the rotating heat dissipation fins 4.

In order to deal with this problem, a rotating mechanism is positioned on the side of the power supply unit 7 of the base member 6 and the rotation member 18 is positioned near openings 9 located on the negative direction side of the axis 10 in the lighting device according to the fourth embodiment shown in FIG. 13. The rotation member 18 increases air flowing out of the openings 9 located on the negative direction side of the axis 10. As a result, the static pressure inside the cover 5 is decreased. Accordingly, air easily flows into the openings 9 located on the positive direction side of the axis 10 to increase mass flow rate inside the cover 5. Thus, as the outgoing air increases, the incoming air also increases to increase the heat dissipation from the heat dissipation fins 4. Since the rotation member 18 and the rotating mechanism are not present on the heat transfer path between the light-emitting element 2 and the heat dissipation fins 4, thermal resistance between the light-emitting element 2 and the heat dissipation fins 4 is not increased.

The rotation member 18 preferably has a shape to guide, by its rotations, air flow to the normal line in the direction of angular velocity, i.e., the direction of the openings 9. The heat dissipation from the rotation member 18 can be increased by forming the rotation member 18 of a material having a high thermal conductivity such as aluminum. The reliability of the rotation member 18 can be improved by forming it of a material having a high rigidity. The weight of the rotation member 18 can be decreased by forming it of a material having a low density. Noise generated by the rotation member 18 can be prevented by lowering the number of revolutions thereof.

Like the first embodiment, the lighting device using LEDs according to the fourth embodiment is capable of increasing the output without decreasing the lighting efficiency and increasing the size.

As described above, an embodiment has the following effects.

Heat dissipation performance can be improved without disturbing the roles conventionally held by globes, diffusion and light guide, by positioning an optical lens to face the light-emitting surface of LEDs, and arranging heat dissipation fins inside the globe so as not to block light. As a result, LEDs can be positioned near the top portion of the globe, i.e., near openings. Accordingly, the trade-off between light and heat dissipation can be solved.

Specifically, a positive direction side of an axis that is perpendicular to the light-emitting surface of the LEDs with the center of the light-emitting surface being set as the point of origin and with a direction in which light is emitted being set as a positive direction is defined as a light-emitting side, and a negative direction side is defined as a heat dissipation side. Since the light-emitting side and the heat dissipation side can be separated from each other, the number of LEDs and the number of fins can be determined separately from each other. Furthermore, embodiments can be applied to a single light source with a high output. Moreover, the shape of fins can be complicated, which allows a higher freedom in design. A high device efficiency can be achieved if no shield is provided within a 1/2 light distribution angle of the optical lens in the heat dissipation side.

Further, an effect can be expected that no shadow may be produced by the heat dissipation fins etc. since the distance between a point of the optical lens from which light is emitted and a point at which the light hits the globe is long. The reason for this is that light emitted from the optical lens are widely dispersed before they reach the globe.

In the described structures, the light-emitting surface of the LEDs does not face the mainstream of air flow. Therefore, the light source is not affected by dust etc.

Since light is distributed by the optical lens, the globe may be made of a material of which the refractive index may not be sufficiently high, such as PC, PMMA, and glass. For example, the globe may be made of Japanese paper. If the housing portion conventionally made of metal is made of the same material as the globe, the appearance may become closer to that of an incandescent light bulb. If portions outside the 1/2 light distribution angle of the optical lens are formed of a material having a high thermal conductivity such as a metal or ceramic, or having a high emissivity, the heat dissipation performance can be improved further.

The heat dissipation may be improved by increasing the globe temperature by shaping the fins in accordance with the shape of the cover so that the fins are in contact with the cover. The shadows of the fins may become unlikely to be seen easily by forming a space between the globe and the fins.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A lighting device comprising:
a light-emitting element having a light-emitting surface;
an optical lens positioned on a positive direction side of an axis that is perpendicular to the light-emitting surface of the light-emitting element with a point of origin being set on a center of the light-emitting surface, a positive direction of the axis being determined as a direction in which light is emitted;
a plurality of heat dissipation fins arranged on a negative direction side of the axis and around the axis that serves as a central axis, the heat dissipation fins being arranged so as not to be present within a range of a 1/2 light distribution angle of light emitted from the optical lens in the positive direction, and the heat dissipation fins being thermally connected to the light-emitting element;
a cover housing the heat dissipation fins, being shaped like a body of rotation with the axis serving as a rotation axis, and having at least one opening in each of the positive direction side and the negative direction side of the axis; and
a base member positioned along the axis and thermally connected to the light-emitting element and the heat dissipation fins.

2. The device according to claim 1, wherein the base member is solid.

3. The device according to claim 1, further comprising:
a base that is positioned on the negative direction side of the axis, and receives a current from outside;
a power supply casing connected to the base; and
a power supply circuit housed in the power supply casing.

4. The device according to claim 3, wherein the power supply casing is not electrically connected with any element other than the base and the power supply circuit.

5. The device according to claim 1, wherein each of the heat dissipation fins is a flat plate that is branched, at a predetermined angle, to form a Y shape at a point somewhere between a base side, which is a side of the axis, of the heat dissipation fin and a top side, which is a side of the cover, of the heat dissipation fin, the predetermined angle being obtained by dividing 2π by the number of heat dissipation fins.

6. The device according to claim 1, further comprising a plurality of heatsinks housed in the cover and arranged concentrically around the axis, the heatsinks being thermally connected to the heat dissipation fins.

7. The device according to claim 1, further comprising a rotating member in a shape of a body of rotation, which rotates itself, is housed in the cover, and is positioned along the axis.

8. The device according to claim 7, wherein the heat dissipation fins make the rotating member.

9. The device according to claim 7, wherein the rotating member is positioned on the negative position side of the axis to be more distant from the point of origin than the base member, or near the at least one opening positioned on the negative side of the axis.

10. The device according to claim 1, wherein a part of the heat dissipation fins is in contact with the cover.

11. The device according to claim 1, wherein the heat dissipation fins are not in contact with the cover.
